(19) United States
(12) Patent Application Publication
(10) Pub. No.: US 2025/0133608 A1
(43) Pub. Date: Apr. 24, 2025

(54) METHOD, APPARATUS AND COMPUTER PROGRAM

(71) Applicant: NOKIA TECHNOLOGIES OY, Espoo (FI)

(72) Inventors: Vinh VAN PHAN, Oulu (FI); Ling YU, Kauniainen (FI); Faranaz SABOURI-SICHANI, Aalborg (DK); Apostolos KOUSARIDAS, Munich (DE); Sayed Ali MARANDI, Aalborg (DK)

(21) Appl. No.: 18/920,331

(22) Filed: Oct. 18, 2024

(30) Foreign Application Priority Data
Oct. 20, 2023 (GB) 2316060.9

(51) Int. Cl. H04W 76/10; H04W 88/04

(52) U.S. Cl. CPC H04W 76/10; H04W 88/04

(57) ABSTRACT

There is provided an apparatus comprising: means for determining a communication request associated with relay discovery and selection for a user equipment-to-network, U2N, relay connection establishment for a first user equipment, UE, and means for, based on the communication request, providing, to a U2N relay UE via at least one first user equipment-to-user equipment, U2U, relay UE, the communication request using an established relay chain between the U2N relay UE and a second UE via the at least one first U2U relay UE.

### CROSS-REFERENCE TO RELATED APPLICATIONS

This application claims priority to Great Britain Application No. 2316060.9, filed Oct. 20, 2023, the entire contents of which are incorporated herein by reference.

### TECHNICAL FIELD

Various examples of this disclosure relate to methods, apparatus, and computer programs for a wireless communication system.

### BACKGROUND

A communication system may be a facility that enables communication sessions between two or more entities, such as user terminals, base stations/access points and/or other nodes by providing carriers between the various entities involved in the communications path. A communication system may be provided, for example, by means of a communication network and one or more compatible communication devices. The communication sessions may comprise communication of data for carrying communications such as voice, electronic mail (email), text message, multimedia and/or content data and so on. Some examples of services provided comprise two-way or multi-way calls, data communication or multimedia services and access to a data network system, such as the Internet.

### SUMMARY

Some examples of this disclosure are described with respect to certain aspects. These aspects are not intended to indicate key or essential features of the various examples, nor are they intended to be used to limit the scope of thereof. Other features, aspects, and elements will be readily apparent to a person skilled in the art in view of this disclosure. For example, it should be appreciated that further aspects may be provided by the combination of any two or more of the various aspects described below.

According to an aspect, there is provided an apparatus comprising: means for determining a communication request associated with relay discovery and selection for a user equipment-to-network, U2N, relay connection establishment for a first user equipment, UE; and means for, based on the communication request, providing, to a U2N relay UE via at least one first user equipment-to-user equipment, U2U, relay UE, the communication request using an established relay chain between the U2N relay UE and a second UE via the at least one first U2U relay UE.

In some examples, at least one of: the first UE, or the second UE, are out-of-coverage of serving cells.

In some examples, the communication request is a direct communication request. In examples, the first UE and the second UE are remote UEs respectively.

In some examples, the communication request associated with relay discovery and selection is associated with a U2N relay UE via at least one U2U relay UE, wherein the communication request is requesting a connection between the first UE and the U2N relay UE via the at least one U2U relay UE. In examples, the communication request comprises information indicating for the relay discovery and selection of the U2N relay UE to use the established relay chain.

In some examples, the means for determining the communication request comprises one of: means for receiving the communication request from at least one of the first user equipment or at least one second U2U relay UE, or means for initiating the communication request.

In some examples, the communication request comprises information associated with relay selection indicating the established relay chain including at least an identity of the U2N relay UE.

In some examples, the apparatus comprises: means for determining whether the communication request comprises information associated with relay selection; means for, when it is determined that the communication request comprises information associated with relay selection, selecting the U2N relay UE using the established relay chain based on the information associated with relay selection; means for, when it is determined that the communication request does not comprise information associated with relay selection: retrieving first information associated with relay selection from the established relay chain, wherein the first information comprises information indicating the established relay chain including at least the identity of the U2N relay UE, and inserting the first information into the communication request.

In some examples, the established relay chain is a part of a multi-hop user equipment-to-network relay connection of the second UE being served by the U2N relay UE and at least one U2U relay UE including the at least one first U2U relay UE.

In some examples, the apparatus comprises: means for receiving, from the U2N relay UE directly or via at least one U2U relay UE, an accept message associated with the communication request, wherein the accept message indicates an acceptance of the communication request; and means for providing, to the first user equipment, the accept message.

In some examples, the apparatus comprises: means for receiving a reject message associated with the communication request, wherein the reject message indicates a rejection of the communication request; means for, based on receiving the reject message: retrieving second information associated with relay selection from a further established relay chain, wherein the second information comprises an identity of a further U2N relay UE, replacing the first information with the second information in the communication request, and providing, to the further U2N relay UE, the communication request using the further established relay chain.

In some examples, the reject message is received from one of: the U2N relay UE directly, the U2N relay UE via at least one U2U relay UE, the U2U relay in the established relay chain directly, or the U2U relay UE in the established relay chain via at least one other U2U relay UE in the established relay chain.

In some examples, the communication request comprises a flag, wherein the flag indicates whether the information associated with relay selection in the communication request was initiated by: the first UE, or a U2U relay UE.

In some examples, one of: the apparatus is for the first UE, the apparatus is comprised in the first UE, the apparatus is the first UE, the apparatus is for a U2U relay user equipment, the apparatus is comprised in a U2U relay user equipment, the apparatus is a U2U relay user equipment.

In some examples, one of: the apparatus is for a U2U relay UE of the established relay chain, or the apparatus is for the first UE and also for a U2U relay UE of the established relay chain.

According to an aspect, there is provided an apparatus comprising: means for initiating a communication request associated with relay discovery and selection for a user equipment-to-network, U2N, relay connection establishment for a first user equipment, UE, wherein the communication request is requesting a connection between the first UE and a U2N relay UE via at least one first user equipment-to-user equipment, U2U, relay UE, wherein the communication request indicates that the at least one first U2U relay UE is permitted to perform relay selection for the connection; and means for providing the communication request to the at least one U2U relay UE.

In some examples, the communication request comprises information associated with relay selection indicating an established relay chain between a U2N relay UE and a second UE via the at least one U2U relay UE including at least an identity of the U2N relay UE, to be used for the connection.

In some examples, the apparatus comprises: means for communicating with a network using the connection that is established between the first UE and the U2N relay via the at least one first U2U relay UE.

In some examples, one of: the apparatus is for the first UE, the apparatus is comprised in the first UE, the apparatus is the first UE.

According to an aspect, there is provided an apparatus comprising: means for receiving, from a user equipment-to-user equipment, U2U, relay user equipment, UE, a communication request associated with relay discovery and selection, wherein the communication request is requesting a connection between a first UE and a user equipment-to-network, U2N, relay UE via at least one U2U relay UE, wherein the communication request indicates that the at least one U2U relay UE is permitted to perform relay selection for the connection; and means for, based on the communication request, providing a response to the communication request to the first UE via the U2U relay UE.

In some examples, the means for, based on the communication request, providing a response to the communication request to the first UE via the U2U relay UE comprises: means for based on the communication request, determining whether to respond with one of: an accept message associated with the communication request, a reject message associated with the communication request, or a relay discovery message associated with the communication request; and means for, based on the determination, providing the response to the first UE via the U2U relay UE.

In some examples, the accept message is a DCA, the reject message is a DCRj, and the relay discovery message associated with the communication request is a DR.

In some examples, the apparatus comprises means for selecting at least one U2U relay UE based on a flag included in the communication request.

In some examples, when it is determined to provide a reject message associated with the communication request, the apparatus comprises: means for including a reject flag with the reject message associated with the communication request in the response, wherein the reject flag indicates that the reject message was initiated by the U2N relay UE.

In some examples, when it is determined to respond with the relay discovery message associated with the communication request, the apparatus comprises means for selecting one or more U2U relay UEs from the at least one U2U relay UE; and means for sending the response to the selected one or more U2U relay UEs individually.

In some examples, one of: the apparatus is for the U2N relay UE, the apparatus is comprised in the U2N relay UE, the apparatus is the U2N relay UE.

According to an aspect, there is provided a method comprising: determining a communication request associated with relay discovery and selection for a user equipment-to-network, U2N, relay connection establishment for a first user equipment, UE; and based on the communication request, providing, to a U2N relay UE via at least one first user equipment-to-user equipment, U2U, relay UE, the communication request using an established relay chain between the U2N relay UE and a second UE via the at least one first U2U relay UE.

In some examples, at least one of: the first UE, or the second UE, are out-of-coverage of serving cells.

In some examples, the communication request is a direct communication request. In examples, the first UE and the second UE are remote UEs respectively.

In some examples, the communication request associated with relay discovery and selection is associated with a U2N relay UE via at least one U2U relay UE, wherein the communication request is requesting a connection between the first UE and the U2N relay UE via the at least one U2U relay UE. In examples, the communication request comprises information indicating for the relay discovery and selection of the U2N relay UE to use the established relay chain.

In some examples, the determining the communication request comprises one of: receiving the communication request from at least one of the first user equipment or at least one second U2U relay UE, or initiating the communication request.

In some examples, the communication request comprises information associated with relay selection indicating the established relay chain including at least an identity of the U2N relay UE.

In some examples, the method comprises: determining whether the communication request comprises information associated with relay selection; when it is determined that the communication request comprises information associated with relay selection, selecting the U2N relay UE using the established relay chain based on the information associated with relay selection; when it is determined that the communication request does not comprise information associated with relay selection: retrieving first information associated with relay selection from the established relay chain, wherein the first information comprises information indicating the established relay chain including at least the identity of the U2N relay UE, and inserting the first information into the communication request.

In some examples, the established relay chain is a part of a multi-hop user equipment-to-network relay connection of the second UE being served by the U2N relay UE and at least one U2U relay UE including the at least one first U2U relay UE.

In some examples, the method comprises: receiving, from the U2N relay UE directly or via at least one U2U relay UE, an accept message associated with the communication request, wherein the accept message indicates an acceptance of the communication request; and providing, to the first user equipment, the accept message.

In some examples, the method comprises: receiving a reject message associated with the communication request, wherein the reject message indicates a rejection of the communication request; based on receiving the reject message: retrieving second information associated with relay selection from a further established relay chain, wherein the second information comprises an identity of a further U2N relay UE; replacing the first information with the second information in the communication request, and providing, to the further U2N relay UE, the communication request using the further established relay chain.

In some examples, the reject message is received from one of: the U2N relay UE directly, the U2N relay UE via at least one U2U relay UE, the U2U relay in the established relay chain directly, or the U2U relay UE in the established relay chain via at least one other U2U relay UE in the established relay chain.

In some examples, the communication request comprises a flag, wherein the flag indicates whether the information associated with relay selection in the communication request was initiated by: the first UE, or a U2U relay UE.

In some examples, the method is performed by the first UE, or a U2U relay user equipment.

In some examples, the method is performed by a U2U relay UE of the established relay chain, or by the first UE which is also configured as a U2U relay UE of the established relay chain.

According to an aspect, there is provided a method comprising: initiating a communication request associated with relay discovery and selection for a user equipment-to-network, U2N, relay connection establishment for a first user equipment, UE, wherein the communication request is requesting a connection between the first UE and a U2N relay UE via at least one first user equipment-to-user equipment, U2U, relay UE, wherein the communication request indicates that the at least one first U2U relay UE is permitted to perform relay selection for the connection; and providing the communication request to the at least one U2U relay UE.

In some examples, the communication request comprises information associated with relay selection indicating an established relay chain between a U2N relay UE and a second UE via the at least one U2U relay UE including at least an identity of the U2N relay UE, to be used for the connection.

In some examples, the method comprises: communicating with a network using the connection that is established between the first UE and the U2N relay via the at least one first U2U relay UE.

In some examples, the method is performed by the first UE.

According to an aspect, there is provided a method comprising: receiving, from a user equipment-to-user equipment, U2U, relay user equipment, UE, a communication request associated with relay discovery and selection, wherein the communication request is requesting a connection between a first UE and a user equipment-to-network, U2N, relay UE via at least one U2U relay UE, wherein the communication request indicates that the at least one U2U relay UE is permitted to perform relay selection for the connection; and based on the communication request, providing a response to the communication request to the first UE via the U2U relay UE.

In some examples, the providing a response to the communication request to the first UE via the U2U relay UE comprises: based on the communication request, determining whether to respond with one of: an accept message associated with the communication request, a reject message associated with the communication request, or a relay discovery message associated with the communication request; and based on the determination, providing the response to the first UE via the U2U relay UE.

In some examples, the accept message is a DCA, the reject message is a DCRj, and the relay discovery message associated with the communication request is a DR.

In some examples, the method comprises: selecting at least one U2U relay UE based on a flag included in the communication request.

In some examples, when it is determined to provide a reject message associated with the communication request, the method comprises: including a reject flag with the reject message associated with the communication request in the response, wherein the reject flag indicates that the reject message was initiated by the U2N relay UE.

In some examples, when it is determined to respond with the relay discovery message associated with the communication request, the method comprises: selecting one or more U2U relay UEs from the at least one U2U relay UE; and sending the response to the selected one or more U2U relay UEs individually.

In some examples, the method is performed by the U2N relay UE.

According to an aspect, there is provided an apparatus comprising: at least one processor, and at least one memory storing instructions that, when executed by the at least one processor, cause the apparatus to perform: determining a communication request associated with relay discovery and selection for a user equipment-to-network, U2N, relay connection establishment for a first user equipment, UE; and based on the communication request, providing, to a U2N relay UE via at least one first user equipment-to-user equipment, U2U, relay UE, the communication request using an established relay chain between the U2N relay UE and a second UE via the at least one first U2U relay UE.

In some examples, at least one of: the first UE, or the second UE, are out-of-coverage of serving cells.

In some examples, the communication request is a direct communication request. In examples, the first UE and the second UE are remote UEs respectively.

In some examples, the communication request associated with relay discovery and selection is associated with a U2N relay UE via at least one U2U relay UE, wherein the communication request is requesting a connection between the first UE and the U2N relay UE via the at least one U2U relay UE. In examples, the communication request comprises information indicating for the relay discovery and selection of the U2N relay UE to use the established relay chain.

In some examples, the determining the communication request comprises one of: receiving the communication request from at least one of the first user equipment or at least one second U2U relay UE, or initiating the communication request.

In some examples, the communication request comprises information associated with relay selection indicating the established relay chain including at least an identity of the U2N relay UE.

In some examples, the apparatus is caused to perform: determining whether the communication request comprises information associated with relay selection; when it is determined that the communication request comprises information associated with relay selection, selecting the U2N relay UE using the established relay chain based on the information associated with relay selection; when it is determined that the communication request does not comprise information associated with relay selection: retrieving first information associated with relay selection from the established relay chain, wherein the first information comprises information indicating the established relay chain including at least the identity of the U2N relay UE, and inserting the first information into the communication request.

In some example, the established relay chain is a part of a multi-hop user equipment-to-network relay connection of the second UE being served by the U2N relay UE and at least one U2U relay UE including the at least one first U2U relay UE.

In some examples, the apparatus is caused to perform: receiving, from the U2N relay UE directly or via at least one U2U relay UE, an accept message associated with the communication request, wherein the accept message indicates an acceptance of the communication request; and providing, to the first user equipment, the accept message.

In some examples, the apparatus is caused to perform: receiving a reject message associated with the communication request, wherein the reject message indicates a rejection of the communication request; based on receiving the reject message: retrieving second information associated with relay selection from a further established relay chain, wherein the second information comprises an identity of a further U2N relay UE; replacing the first information with the second information in the communication request, and providing, to the further U2N relay UE, the communication request using the further established relay chain.

In some examples, the reject message is received from one of: the U2N relay UE directly, the U2N relay UE via at least one U2U relay UE, the U2U relay in the established relay chain directly, or the U2U relay UE in the established relay chain via at least one other U2U relay UE in the established relay chain.

In some examples, the communication request comprises a flag, wherein the flag indicates whether the information associated with relay selection in the communication request was initiated by: the first UE, or a U2U relay UE.

In some examples, one of: the apparatus is for the first UE, the apparatus is comprised in the first UE, the apparatus is the first UE, the apparatus is for a U2U relay user equipment, the apparatus is comprised in a U2U relay user equipment, the apparatus is a U2U relay user equipment.

In some examples, one of: the apparatus is for a U2U relay UE of the established relay chain, or the apparatus is for the first UE and also for a U2U relay UE of the established relay chain.

According to an aspect, there is provided an apparatus comprising: at least one processor, and at least one memory storing instructions that, when executed by the at least one processor, cause the apparatus to perform: initiating a communication request associated with relay discovery and selection for a user equipment-to-network, U2N, relay connection establishment for a first user equipment, UE, wherein the communication request is requesting a connection between the first UE and a U2N relay UE via at least one first user equipment-to-user equipment, U2U, relay UE, wherein the communication request indicates that the at least one first U2U relay UE is permitted to perform relay selection for the connection; and providing the communication request to the at least one U2U relay UE.

In some examples, the communication request comprises information associated with relay selection indicating an established relay chain between a U2N relay UE and a second UE via the at least one U2U relay UE including at least an identity of the U2N relay UE, to be used for the connection.

In some examples, the apparatus is caused to perform: communicating with a network using the connection that is established between the first UE and the U2N relay via the at least one first U2U relay UE.

In some examples, one of: the apparatus is for the first UE, the apparatus is comprised in the first UE, the apparatus is the first UE.

According to an aspect, there is provided an apparatus comprising: at least one processor, and at least one memory storing instructions that, when executed by the at least one processor, cause the apparatus to perform: receiving, from a user equipment-to-user equipment, U2U, relay user equipment, UE, a communication request associated with relay discovery and selection, wherein the communication request is requesting a connection between a first UE and a user equipment-to-network, U2N, relay UE via at least one U2U relay UE, wherein the communication request indicates that the at least one U2U relay UE is permitted to perform relay selection for the connection; and based on the communication request, providing a response to the communication request to the first UE via the U2U relay UE.

In some examples, the providing a response to the communication request to the first UE via the U2U relay UE comprises: based on the communication request, determining whether to respond with one of: an accept message associated with the communication request, a reject message associated with the communication request, or a relay discovery message associated with the communication request; and based on the determination, providing the response to the first UE via the U2U relay UE.

In some examples, the accept message is a DCA, the reject message is a DCRj, and the relay discovery message associated with the communication request is a DR.

In some examples, the apparatus is caused to perform: selecting at least one U2U relay UE based on a flag included in the communication request.

In some examples, when it is determined to provide a reject message associated with the communication request, the apparatus is caused to perform: including a reject flag with the reject message associated with the communication request in the response, wherein the reject flag indicates that the reject message was initiated by the U2N relay UE.

In some examples, when it is determined to respond with the relay discovery message associated with the communication request, the apparatus is caused to perform: selecting one or more U2U relay UEs from the at least one U2U relay UE; and sending the response to the selected one or more U2U relay UEs individually.

In some examples, one of: the apparatus is for the U2N relay UE, the apparatus is comprised in the U2N relay UE, the apparatus is the U2N relay UE.

According to an aspect, there is provided a computer program comprising instructions, which when executed by an apparatus, cause the apparatus to perform at least the following: determining a communication request associated with relay discovery and selection for a user equipment-to-network, U2N, relay connection establishment for a first user equipment, UE; and based on the communication request, providing, to a U2N relay UE via at least one first user equipment-to-user equipment, U2U, relay UE, the communication request using an established relay chain between the U2N relay UE and a second UE via the at least one first U2U relay UE.

According to an aspect, there is provided a computer program comprising instructions, which when executed by an apparatus, cause the apparatus to perform at least the following: initiating a communication request associated with relay discovery and selection for a user equipment-to-network, U2N, relay connection establishment for a first user equipment, UE, wherein the communication request is requesting a connection between the first UE and a U2N relay UE via at least one first user equipment-to-user equipment, U2U, relay UE, wherein the communication request indicates that the at least one first U2U relay UE is permitted to perform relay selection for the connection; and providing the communication request to the at least one U2U relay UE.

According to an aspect, there is provided a computer program comprising instructions, which when executed by an apparatus, cause the apparatus to perform at least the following: receiving, from a user equipment-to-user equipment, U2U, relay user equipment, UE, a communication request associated with relay discovery and selection, wherein the communication request is requesting a connection between a first UE and a user equipment-to-network, U2N, relay UE via at least one U2U relay UE, wherein the communication request indicates that the at least one U2U relay UE is permitted to perform relay selection for the connection; and based on the communication request, providing a response to the communication request to the first UE via the U2U relay UE.

According to an aspect, there is provided an apparatus comprising: circuitry configured to perform: determining a communication request associated with relay discovery and selection for a user equipment-to-network, U2N, relay connection establishment for a first user equipment, UE; and circuitry configured to perform: based on the communication request, providing, to a U2N relay UE via at least one first user equipment-to-user equipment, U2U, relay UE, the communication request using an established relay chain between the U2N relay UE and a second UE via the at least one first U2U relay UE.

According to an aspect, there is provided an apparatus comprising: circuitry configured to perform: initiating a communication request associated with relay discovery and selection for a user equipment-to-network, U2N, relay connection establishment for a first user equipment, UE, wherein the communication request is requesting a connection between the first UE and a U2N relay UE via at least one first user equipment-to-user equipment, U2U, relay UE, wherein the communication request indicates that the at least one first U2U relay UE is permitted to perform relay selection for the connection; and circuitry configured to perform: providing the communication request to the at least one U2U relay UE.

According to an aspect, there is provided an apparatus comprising: circuitry configured to perform: receiving, from a user equipment-to-user equipment, U2U, relay user equipment, UE, a communication request associated with relay discovery and selection, wherein the communication request is requesting a connection between a first UE and a user equipment-to-network, U2N, relay UE via at least one U2U relay UE, wherein the communication request indicates that the at least one U2U relay UE is permitted to perform relay selection for the connection; and circuitry configured to perform: based on the communication request, providing a response to the communication request to the first UE via the U2U relay UE. A computer product stored on a medium may cause an apparatus to perform the methods as described herein.

A non-transitory computer readable medium comprising program instructions, that, when executed by an apparatus, cause the apparatus to perform the methods as described herein.

An electronic device may comprise apparatus as described herein.

In the above, various aspects have been described. Various other aspects and further examples are also described in the following detailed description and in the claims.

According to some aspects, there is provided the subject matter of the independent claims. Some further aspects are defined in the dependent claims. Embodiments that do not fall under the scope of the claims are to be interpreted as examples useful for understanding the disclosure.

### LIST OF ABBREVIATIONS

AF: Application Function
AMF: Access and Mobility Management Function
AN: Access Network
BS: Base Station
CN: Core Network
DL: Downlink
DCA: Direct Communication Accept
DCR: Direct Communication Request
DCRj: Direct Communication Reject
DR: Discovery Response
DS: Discovery Solicitation
eNB: eNodeB
E2E: End-to-End
gNB: gNodeB
IC: In-Coverage
IIoT: Industrial Internet of Things
LTE: Long Term Evolution
NEF: Network Exposure Function
NG-RAN: Next Generation Radio Access Network
NF: Network Function
NR: New Radio
NRF: Network Repository Function
NW: Network
MS: Mobile Station
MH: Multi-hop
OoC: Out-of-Coverage
PCF: Policy Control Function
PLMN: Public Land Mobile Network
RAN: Radio Access Network
RD: Relay Discovery
RF: Radio Frequency
RSRP: Reference Signal Received Power
SMF: Session Management Function
SL: Sidelink
SH: Single-hop
UE: User Equipment
UDR: Unified Data Repository
UDM: Unified Data Management
UL: Uplink
UPF: User Plane Function
Uu: Air interface between UE and BS (e.g. between a UE and an eNB/gNB in 3GPP standards)
U2N: UE-to-Network

U2U: UE-to-UE
3GPP: 3^{rd} Generation Partnership Project
5G: 5^{th} Generation
5GC: 5G Core network
5G-AN: 5G Radio Access Network
5GS: 5G System

### BRIEF DESCRIPTION OF DRAWINGS

Some examples will now be described with reference to the accompanying Figures (FIGS.) in which:

FIG. 1 shows a schematic representation of a 5G system;

FIG. 2 shows a schematic representation of a control apparatus;

FIG. 3 shows a schematic representation of a terminal;

FIG. 4 shows a schematic representation of a relay chain for multi-hop sidelink communications;

FIGS. 5a to 5d show schematic representations of different scenarios for remote user equipment;

FIG. 6 shows an example signaling diagram for establishing a multi-hop relay connection;

FIG. 7 shows an example signaling diagram for establishing a multi-hop relay connection;

FIG. 8 shows another example signaling diagram for establishing a multi-hop relay connection;

FIG. 9 shows an example method flow diagram performed by an apparatus;

FIG. 10 shows another example method flow diagram performed by an apparatus;

FIG. 11 shows another example method flow diagram performed by an apparatus; and

FIG. 12 shows a schematic representation of a non-volatile memory medium storing instructions which when executed by a processor allow a processor to perform one or more of the steps of the method of FIGS. 9 to 11.

### DETAILED DESCRIPTION

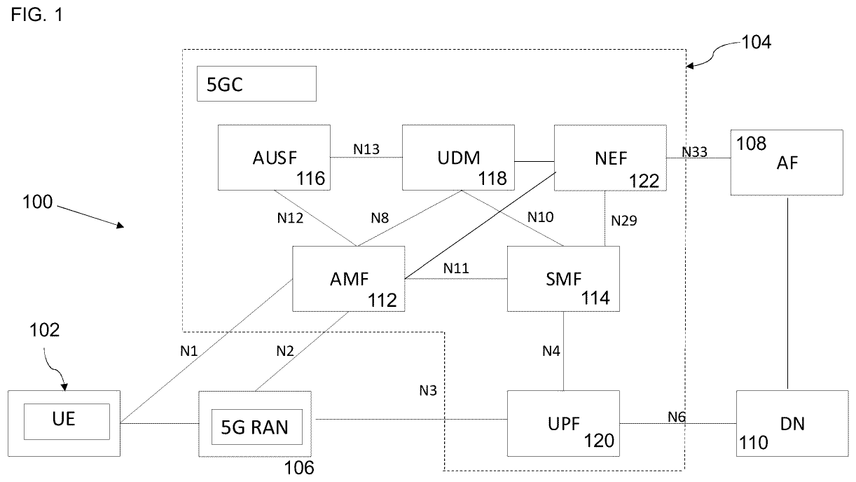

In the following, various examples of the disclosure are explained with reference to mobile communication devices capable of communication via a wireless cellular system and mobile communication systems serving such mobile communication devices. Before explaining in detail the various examples, certain general aspects of a wireless communication system and mobile communication devices are briefly explained with reference to FIGS. 1 to 3 to assist in understanding the technology underlying the described examples.

FIG. 1 shows a schematic representation of a wireless communication system 100. The wireless communication system 100 comprises one or more devices 102, such as user equipment (UE), or terminals. The wireless communication system 100 comprises a 5G system (5GS). The 5GS comprises a 5G radio access network (5G-RAN) 106, a 5G core network (5GC) 104 comprising one or more network functions (NF), one or more application functions (AFs) 108, and one or more data networks (DNS) 110 (or portion(s) thereof).

The 5G-RAN 106 may comprise one or more gNodeB (gNB) distributed unit (DU) functions connected to one or more gNodeB (gNB) centralized unit (CU) functions.

The 5GC 104 comprises an access and mobility management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown may be applicable to 3GPP 5G standards. However, some examples may also be applicable to 6G, 5G-advanced, 4G, 3G and other 3GPP standards.

In a wireless communication system, such as wireless communication system 100 shown in FIG. 1, mobile communication devices/terminals or user apparatuses, and/or user equipments (UE), and/or machine-type communication devices are provided with wireless access via at least one base station or similar wireless transmitting and/or receiving node or point. A terminal may be provided with an appropriate signal receiving and transmitting apparatus for communications, that can, for example, enable (or otherwise facilitate) access to a communication network or communications directly with other devices. The communication device may access a carrier provided by a base station or access point, and transmit and/or receive communications on the carrier.

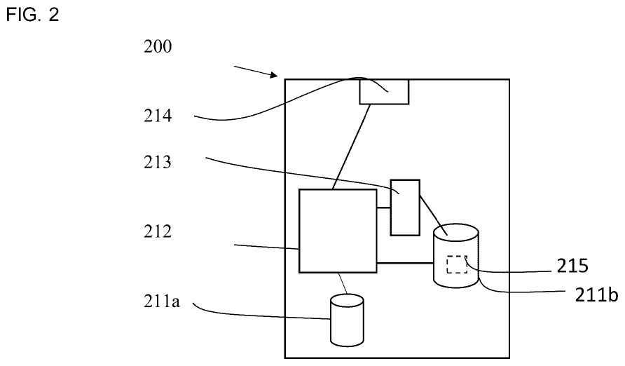

FIG. 2 illustrates an example of a control apparatus 200. The control apparatus 200 may be for controlling a function of one or more network entities/network functions, such as the entities of the 5G-RAN 106 or the 5GC 104 as illustrated on FIG. 1. The control apparatus 200 comprises at least one random access memory (RAM) 211a, at least one read only memory (ROM) 211b, at least one processor 212, 213 and an input/output interface 214. The at least one processor 212, 213 is coupled to the RAM 211a and the ROM 211b. The at least one processor 212, 213 may be configured to execute an appropriate software code 215. The software code 215 may, for example, allow to perform one or more steps to perform one or more of the aspects or examples. The software code 215 may be stored in the ROM 211b. The control apparatus 200 may be interconnected with another control apparatus 200 controlling another entity/function of the 5G-RAN 106 or the 5GC 104. In some examples, each function of the 5G-RAN 106 or the 5GC 104 comprises a control apparatus 200. In alternative examples, two or more functions of the 5G-RAN 106 or the 5GC 104 may share a control apparatus 200. The control apparatus 200 may comprise one or more circuits, or circuitry (not shown), which may be configured to perform one or more of the aspects or examples.

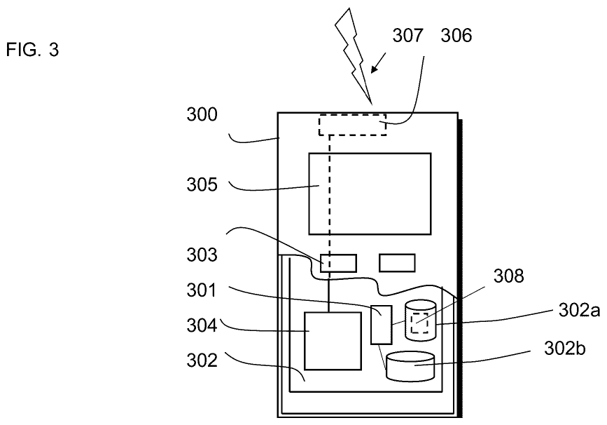

FIG. 3 illustrates an example of a communication device 300, such as a device 102 illustrated in FIG. 1. The communication device 300 may be provided by any device capable of sending and receiving radio signals. In some examples, a communication device is a user equipment, a mobile station (MS) or mobile device (such as, a mobile phone or what is known as a ‘smart phone’), a computer provided with a wireless interface card or other wireless interface facility (e.g., USB dongle), a personal data assistant (PDA) or a tablet provided with wireless communication capabilities, a machine-type communications (MTC) device, a Cellular Internet of things (cIoT) device or any combinations of these or the like. The communication device 300 may provide, for example, communication of data for carrying communications. The communications may be one or more of voice, electronic mail (email), text message, multimedia, data, machine data and so on.

The communication device 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided, for example, by means of a radio part and associated antenna arrangement. The antenna arrangement may be arranged internally and/or externally to the mobile device.

The communication device 300 may be provided with at least one processor 301, at least one ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may, for example, allow to perform one or more of the aspects. The software code 308 may be stored in the ROM 302a. The communication device 300 may comprise one or more circuits, or circuitry (not shown), which may be configured to perform one or more of the aspects or examples.

The processor, storage and other relevant control apparatus may be provided on an appropriate circuit board and/or in chipsets. This feature is denoted by reference 304. In some examples, the device may be optionally equipped with a user interface, such as keypad 305, touch sensitive screen or pad, combinations thereof or the like. In some examples, one or more of a display, a speaker and a microphone may be optionally provided, depending on the type of the device.

One or more of the following examples are related to device-to-device communications, such as New Radio (NR) sidelink (SL) communications. Sidelink is a feature of the 5G system that enables (or otherwise facilitates) direct communication between two devices without the participation of a base station in the transmission and reception of data traffic. For sidelink based communications, there may be single-hop (SH) or multi-hop (MH) UE-to-Network (U2N) relay communications.

NR SL based single-hop (SH) U2N relay uses a single UE-to-Network (U2N) relay UE between a remote UE and a serving network. The MH U2N relay may be considered an extension of the SH U2N relay where the SH SL between a remote UE and a U2N relay UE may be extended to MH SL using SH or MH UE-to-UE (U2U) relay between the remote UE and the U2N relay UE. That is, the MH SL between the remote UE and the U2N relay UE is based on using either SH U2U relay via a single U2U relay UE or MH U2U relay via more than one U2U relay UEs. U2N relay and U2U relay may be based on either layer 2 (L2) or L3 relay solution. In MH U2N relay, U2N relay and U2U relay may not have to be based on the same L2 or L3 relay solution. For example, a remote UE may use a L2 U2N relay UE via one or more L3 U2U relay UEs between the remote UE and the L2 U2N relay UE to connect to a serving gNB. In this case, the U2N relay connection between the remote UE and the serving gNB, via the L2 U2N relay UE, is based on L2 U2N relay solution, while an extended SL connection between the remote UE and the L2 U2N relay UE, via one or more L3 U2N relay UEs, is based on L3 U2U relay solution.

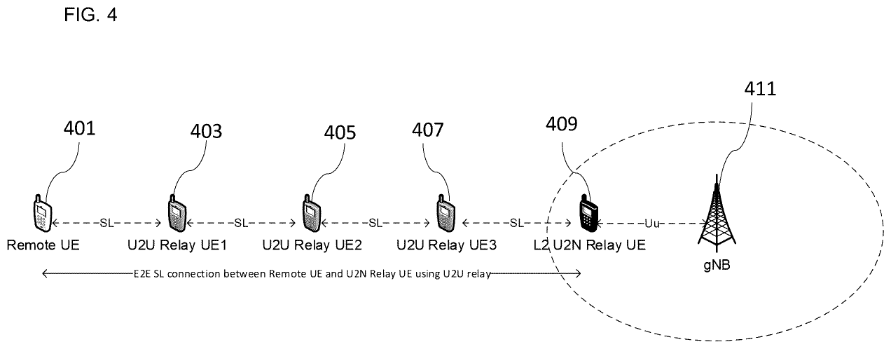

FIG. 4 shows a schematic representation of a relay chain for multi-hop sidelink communications.

There is provided a remote UE 401 which does not have a direct connection to a network or base station. Stated differently, the remote UE 401 is out of coverage of a cell of a base station. There are provided a first U2U relay UE1 403, a second U2U relay UE2 405, and a third U2U relay UE3 407. There is also provided a U2N relay UE 409 which is connected to (and in coverage of) a gNB 411. There is an extended end-to-end (E2E) sidelink connection between the remote UE 401 and the U2N relay UE 409 using the multi-hops of the first, second and third U2U relay UEs 403, 405, 407.

As there are a plurality of U2U relay UEs in the relay chain, this is referred to a multi-hop.

In this manner, FIG. 4 shows an SL based L2 MH U2N relay connection for the remote UE 401 via the L2 U2N relay UE 409 to the serving gNB 411, where the SL based connection between the remote UE 401 and the L2 U2N relay UE 409 is provided via the three U2U relay UEs 403, 405, 407.

In an MH U2N relay, the U2N relay UE 409 is in a good (e.g., direct) Uu coverage (e.g. DL RSRP at the U2N relay UE 409 is above a threshold) of the serving gNB/network 411. This is referred to as in-coverage (IC) status. The remaining UEs, including the remote UE 401 and the U2U relay UEs 403, 405, 407, may be outside direct Uu coverage of the serving network 409. This is referred to as out-of-coverage (OoC) status.

For an L2 MH U2N relay, after the U2N relay connection to the gNB 411 is set up for the remote UE 401, at least the remote UE 401 and the serving U2N relay UE 409 are in RRC_CONNECTED state of the serving gNB 411. The remaining UEs, including at least one U2U relay UE 403, 405, 407, may be in any state of their serving network(s) (e.g. RRC_IDLE/INACTIVE or RRC_CONNECTED towards the same or different serving gNB(s) of the same or different serving network(s), compared to that of the remote UE 401 and the U2N relay UE 409) or remaining in OoC status and in DETACHED state.

For an L3 MH U2N relay, the U2N relay UE 409 will be in RRC_CONNECTED state of the serving gNB 411. The other UEs (including the remote UE 401) may not be in RRC_CONNECTED state.

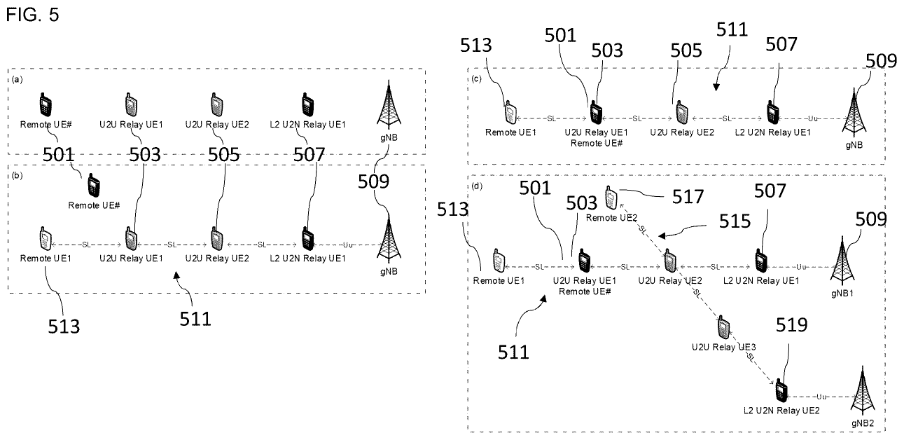

FIGS. 5a to 5d show schematic representations of different scenarios for remote user equipments.

In FIG. 5a, there is provided a remote UE 501, a U2U relay UE1 503, a U2U relay UE2 505, and a U2N relay UE 507. The U2N relay UE 507 is in coverage of a gNB 509. In FIG. 5a there are no connections established between the UEs 501, 503, 505, 507, including the remote UE 501 of interest or between the UEs 503, 505, 507 and the network/gNB 509. In this scenario, the remote UE 501 may need to perform a general, or blind, MH U2N relay discovery and selection for finding and connecting to a suitable U2N relay UE via one or more U2U relay UE(s). The suitability here may include at least some upper-layer criteria (such that the remote UE 501 and the serving U2N relay UE 507 are from an authorized PLMN). The blind MH U2N relay discovery and selection may be initiated by the remote UE 501 broadcasting a blind MH U2N relay discovery (RD) solicitation to find a suitable U2N relay UE(s) 507 that may serve the remote UE 501 to connect to a target PLMN, for example. A U2U relay UE (e.g. U2U relay UE1 503), upon receiving the blind MH U2N RD solicitation of the remote UE 501 (from the remote UE or another U2U relay UE(s)) may forward it further by broadcasting it if certain conditions are met. For example, reference signal received power (RSRP) on the received blind MH U2N relay discovery (RD) solicitation is above a threshold and the maximum number of hops or delay budget for forwarding, based on the received blind MH U2N relay discovery (RD) solicitation, still allows. If the blind MH U2N RD solicitation reaches the U2N relay UE 507, the U2N relay UE 507 may select one or more U2U relay UE(s) 505 from which the blind MH U2N RD solicitation is received with an RSRP above a threshold to send a MH U2N RD response to. This triggers similar U2U relay selection to forward the MH U2N RD response from U2U relay UE2 505 to U2U relay UE1 503 back to the remote UE 501 in downstream. The remote UE 501 may then select a U2N relay UE to establish first an end-to-end (E2E) MH U2U relay connection with the selected U2N relay UE 507. The remote UE 501 may then communicate with the selected U2N relay UE 507 for establishing a MH U2N relay connection with the serving network 509 via the selected U2N relay UE 507. However, this process is associated with some problems. For example, the blind multi-hop (MH) U2N relay discovery and selection comprises two phases including: (i) MH U2N relay discovery; and (ii) MH U2N relay selection and E2E sidelink (SL) MH relay connection setup between the remote UE and selected U2N relay UE via a number of selected U2U relay UE(s). These may take considerable time or, that is, high latency. Furthermore, the broadcast blind MH U2N relay discovery (RD) solicitation may cause unnecessary forwarding of the solicitation in all possible directions further away from coverage of the target PLMN. This is known as a message flooding issue.

FIG. 5b shows an example where the remote UE 501 is in proximity of the U2U relay UE1 503 that is serving an E2E SL connection 511 between a remote UE1 513 and the U2N relay UE 507.

FIG. 5c shows an example where the remote UE 501 is the same (i.e. the same UE) as the U2U relay UE1 503 that is serving the E2E SL connection 511 between the remote UE1 513 and the U2N relay UE 507.

FIG. 5d shows an example where, in addition to that of the example shown in FIG. 5c, the U2U relay UE2 505 is serving another E2E SL connection 515 between a remote UE2 517 and a U2N relay UE2 519.

However, for the scenarios shown in FIGS. 5b to 5d, a similar relay discovery and selection process, as is used in FIG. 5a, may also be utilised. However, as discussed above, this process may have a high latency, and is prone to message flooding issues.

In some systems, U2N relay discovery and selection may be performed by the remote UE when it is to find and connect to a U2N relay UE for possible access to the network. In these systems, after discovering and selecting the U2N relay UE, the remote UE may perform an SL connection establishment with the selected U2N relay UE. The SL connection establishment is initiated by the remote UE sending a Direct Communication Request (DCR) to the selected U2N relay UE using unicast. U2U relay discovery and selection may be integrated in SL connection establishment procedure, or be based on using discovery procedure.

In some systems, for U2U relay discovery and selection, a remote UE is assumed to know information about a target UE (e.g. a U2N relay UE) which the remote UE needs to find U2U relay UE(s) to connect to beforehand. This may not always be known by a remote UE, as the remote UE may is to discover relay UE candidates for both U2U relay and U2N relay (in scenarios shown in FIGS. 5a and 5b, for example). That is, the remote UE may not know which U2N relay UE can be selected beforehand. In this regard, the use of these systems to be extended for MH U2N relay, that the remote UE initiates DCR integrated with U2U and U2N relay discovery and selection, is not straightforward. Furthermore, in these systems, a first message from a remote UE, e.g. a DCR or Discovery Solicitation (DS), is broadcasted and, thus, “flooded” by the remote UE and subsequent U2U relay UEs.

One or more of the examples below aim to address one or more of the problems identified above as well as problems otherwise apparent to a skilled person in the relevant arts in view of the disclosure.

In some examples, there is provided an apparatus configured for determining a communication request associated with relay discovery and selection for a user equipment-to-network, U2N, relay connection establishment for a first user equipment, UE. The apparatus is further configured for, based on the communication request, providing, to a U2N relay UE via at least one first user equipment-to-user equipment, U2U, relay UE, the communication request using an established relay chain between the U2N relay UE and a second UE via the at least one first U2U relay UE.

In some examples, it is faster and more efficient for MH U2N relay discovery and selection for the remote UE if an existing MH U2N relay connection(s) (as shown in FIGS. 5b to 5d) of a U2U relay candidate is utilized.

One or more of the following examples may address how to enable and facilitate utilization of an existing multi-hop U2N relay connection for a remote UE. Furthermore, what to do if an attempt to utilize, such an existing multi-hop U2N relay connection fails.

Some of the following examples show an integrated MH U2N relay discovery and selection. The use of broadcast is minimised during the MH U2N relay discovery and selection (e.g., as much as possible) in order to speed up the setup of an E2E SL connection between a remote UE and a selected U2N relay UE. This may reduce the message flooding overhead (e.g. caused by broadcasting). Some examples show the utilization of relay selection at any suitable hop or stage by the remote UE and/or involved U2U relay UE(s) in MH U2N relay discovery and selection for the remote UE. As the relay selection may be actioned at any hop or stage in a relay chain, the relay selection may be described as a ‘proactive’ relay selection. The proactive relay selection is based on using an existing MH U2N relay connection, also referred as relay chain, of the remote UE and/or involved U2U relay UE(s) and thus SL unicast is used. For example, in FIG. 5b the remote UE #is in proximity of the U2U relay UE1 which is currently serving a relay chain for the remote UE1. In this scenario, the U2U relay UE1 upon determining to be a relay UE candidate to serve the remote UE #may be allowed to perform a (proactive) relay selection for the remote UE #by requesting a MH U2U relay connection to the U2N relay UE1 using its existing relay chain.

In FIG. 5c, the remote UE #, which is the same as the U2U relay UE1 serving the existing relay chain for the remote UE1, may be configured to perform a relay selection for itself. This may be applied for the example in FIG. 5d as well. In addition, when relay selection of the U2N relay UE1 initiated by the remote UE #in FIG. 5d fails and the failure is due to the U2N relay UE1 (e.g. if it is not able to or not willing to act as a U2N relay UE for remote UE #or if it has reached its capacity limit), the U2U relay UE2 may be allowed to perform a subsequent proactive relay (re) selection of the U2N relay UE2 for the remote UE #using a second relay chain that it is serving/part of.

In some examples, in the scenario of FIG. 5d, the U2U relay UE2 may overwrite the relay selection (e.g. overwriting information in the request) that was initiated by the remote UE #or perform a parallel proactive relay selection for the remote UE #using the second relay chain upon receiving, e.g., the DCR of the remote UE #requesting for setting up an E2E connection with the U2U relay UE1 using the first relay chain.

A relay selection (or ‘proactive’ relay selection) may be performed by either a remote UE or a U2U relay UE(s) for a MH U2N relay request from the remote UE. The relay selection may include possible reattempt(s) to perform the relay selection by a U2U relay UE when the previous relay selection fails for the same or ongoing MH U2N relay request of the remote UE, for example. This, therefore, avoids the need for the remote UE to initiate a new MH U2N relay request.

In some examples, there is provided a DCR procedure for optimized (e.g., an integrated, fast, and/or efficient) MH U2N relay discovery and selection. The DCR procedure/DCR message may be described as “open” DCR. The “open” DCR allows for MH U2N relay discovery and selection to be performed by either a remote UE or a U2U relay UE by utilizing an established relay chain that the remote UE has discovered (or is serving) when acting as a U2U relay UE (e.g. FIGS. 5c and 5d) or that the U2U relay UE is serving. The “open” DCR also allows for a U2U relay UE to add (or modify) relay selection information (e.g. add or modify information associated with an established relay chain in the DCR). In an “open” DCR, information of a particular target UE (e.g. a selected U2N relay UE) may not be provided by the remote UE from the start of the relay connection establishment. This information may be left “open” for the U2U relay UE that performs the relay selection to determine and then include in the DCR, during U2N relay UE discovery and selection for MH U2N relay requested by the remote UE. In some examples, when information of the target UE is initially included in the “open” DCR, the U2U relay UE that performs the relay selection for the DCR of the remote UE may be allowed to overwrite the information for enhancing robustness for the DCR as well as the relay selection. The request (e.g. open DCR) may indicate that a U2U relay UE is permitted to perform relay selection for a connection. In other examples, the type (or formatting) of the message (e.g. DCR) may indicate (e.g., implicitly) that a U2U relay UE is permitted to perform relay selection for a connection.

In some examples, a DCR is provided by the remote UE, where the DCR is associated with relay connection establishment. It should be understood that this is given as an example only. In other examples, at least one of the following may be used: a communication request, communication request message, a request, or a request message. In further examples, any suitable message or request message may be used.

In some examples, a remote UE may be configured by the serving network to determine and initiate a DCR in the uplink direction for MH U2N relay discovery and selection even when the remote UE does not have a target U2N relay UE to select beforehand. This “open” DCR, as initiated by the remote UE, may include information associated with relay selection utilizing a known U2N relay UE and an associated relay chain. The relay selection information may include, for example, an ID of the target U2N relay UE and/or an ID of an associated remote UE of the associated relay chain. When the (L2) IDs of both the target U2N relay UE and associated remote UE are included, a single relay chain is selected to be utilized. When either of the (L2) IDs of the target U2N relay UE and associated remote UE is included, any of the paths associated with either the target U2N relay UE or the remote UE may be selected and utilized. It is assumed that the DCR may include further information, such as MH U2N relay enabled indication, relevant UE ID(s) and authorized PLMN ID(s) of the remote UE, maximum allowed number of hops, timing information such as a terminating time of the DCR, etc.

When the DCR does include relay selection information (e.g., the remote UE is already member of an existing MH U2N chain): the remote UE sends the DCR using SL unicast to a neighbouring U2U relay UE in the associated relay chain (see, for example, FIGS. 5c and 5d). When the DCR does not include relay selection information: the remote UE sends the “open” DCR using SL broadcast, allowing a U2U relay UE in the upstream to perform relay selection for the DCR of the remote UE (see, for example, FIGS. 5a and 5b). The DCR without relay selection information allows a U2U relay UE that is involved in the MH U2N relay discovery and selection for the remote UE to add or change the relay selection information in the received DCR before forwarding the DCR further. This may be under the control of the remote UE, e.g., via providing control information or setting constraints or restrictions in the DCR initiated by the remote UE. In order to differentiate the proactive relay selection initiated by the remote UE from that initiated by a U2U relay UE, a first indication (e.g., 1-bit flag) may be included along with the relay selection information. For example, the first indication is set to 1 (True) if the relay selection information is initiated by the remote UE, and vice versa.

In response to the DCR, either Direct Communication Accept (DCA), Direct Communication Reject (DCRj), or Discovery Response (DR) may be provided by a U2N relay UE that has received the DCR, also referred to as the receiving U2N relay UE. The remote UE may receive more than one DCA from different neighbouring U2U relay UEs (with SL-RSRP or RD-RSRP above a configured threshold) for the DCR it initiated. This means that more than one possible relay chain to different U2N relay UEs may be established for the remote UE. In this case, the remote UE may select one of them and release the rest. A subsequent DCR of the remote UE for a retry after receiving DCRj may include a list of non-preferred or excluded U2N relay UE(s) and/or U2U relay UE(s) which reject the previous open DCR of the remote UE. The L2 ID of the source relay UE of the DCRj may be included in the DCRj. The L2 ID of U2N relay UE or U2U relay UE that rejects the DCR of the remote UE may be included in the DCRj to be sent back towards the remote UE in the downlink direction.

In some examples, a U2N relay UE may be configured by the serving network to determine, upon receiving one or more instance(s) of a DCR of the remote UE from one or more U2U relay UE(s) (with SL-RSRP or RD-RSRP above a configured threshold), whether and how to respond to the DCR in the downlink direction, as follows.

The U2N relay UE may determine whether to respond with a DCA, DCRj or DR or not. This may be left up to the U2N relay UE's implementation. In some examples, the U2N relay UE determines to respond to the DCR of the remote UE with DCA or DCRj upon receiving the DCR including relay selection information (in this case the open DCR is sent/received using unicast). The U2N relay UE selects one of the one or more U2U relay UE(s), prioritizing U2U relay UE(s) that sent the DCR with relay selection information. This determination may be based on the first indication (as discussed above). The U2N relay UE then sends DCA or DCRj to the selected U2U relay UE (to be forwarded to the remote UE). DCRj may include a second indication (e.g., 1-bit flag) to indicate whether DCRj is initiated from U2N relay UE or U2U relay UE. In case the DCRj is initiated by the U2N relay UE, the second indication is set to 1 (True) for example.

In some examples, the U2N relay UE determines to respond with a DR upon receiving DCR without relay selection information (in this example, the DCR may be sent/received using broadcast). The U2N relay UE may select up to a configured maximum number of U2U relay UE(s) from the one or more U2U relay UE(s). The U2N relay UE then sends the DR to the selected U2U relay UE(s) individually (to be forwarded to the remote UE).

In some examples, a U2U relay UE may be configured by the serving network and/or controlled by the remote UE to determine, upon receiving one or more instance(s) of a DCR of the remote UE (from the remote UE and/or other U2U relay UE(s)) (with SL-RSRP or RD-RSRP above a configured threshold), to perform one or more operations as follows.

In some examples, when the one or more received instances of the DCR include relay selection information associated with at least one U2N relay UE, and when the U2U relay UE is able to accept the DCR of the remote UE: the U2U relay UE selects one of the received instance(s) of the DCR with relay selection information for each of the respective U2N relay UE(s). The U2U relay UE may prioritize the relay selection information initiated by the remote UE (as indicated by the first indication set to True). In some examples, the U2U relay UE may be configured to select one of the received instance(s) of the DCR with relay selection information across all of the respective U2N relay UE(s) for reducing overhead further. The selection may be based on SL conditions (RSRP ranks between the U2U relay UE and its neighbours from which the DCR instances are received) or random selection provided that all the selectable options should meet a predefined SL condition (RSRP above a threshold). Then, the U2U relay UE forwards the selected instance(s) of the DCR towards the at least one respective U2N relay UE utilizing the associated relay chain(s) indicated in the relay selection information of the selected instance(s) of the open DCR using SL unicast.

In some examples, when the U2U relay UE is not able to accept the DCR from the remote UE, the U2U relay UE may determine whether to send a DCRj or not. This may be left up to the U2U relay UE's implementation, at least in response to the DCR with the relay selection information initiated by other U2U relay UE and not by the remote UE. This means the U2U relay UE may be configured to send DCRj if it cannot accept the DCR with the relay selection information initiated by the remote UE. In some examples, DCRj initiated from an intermediate U2U relay UE in the relay chain may help to trigger a retry of initiating a DCR for MH U2N relay discovery and selection from the remote UE. In some examples, when the U2U relay UE determines to send DCRj: the U2U relay UE may send DCRj to each sender or one or more selected sender(s) of the at least one received instance of the DCR with relay selection information. The second indication is set to 0 (False) in this example. Furthermore, an ID of the U2U relay UE may be included in DCRj to identify the source U2U relay UE of DCRj. This may be used by the remote UE to avoid selecting relay UEs of the failed relay chain.

In some examples, when the DCR does not comprise relay selection information and the U2U relay UE is able to accept the open DCR of the remote UE, then it may be determined by the U2U relay UE whether the U2U relay UE is currently serving a relay chain for another remote UE. In some examples, when the U2U relay UE is serving at least one relay chain (e.g. an established/existing relay chain that is ongoing for another remote UE) to the same serving network of the remote UE then the at least one relay chain may be utilized for the remote UE (e.g. the scenario shown in FIG. 5b). The U2U relay UE determines a relay selection information associated with one of the at least one relay chain and adds the relay selection information to the DCR of the remote UE. The first indication may be set to 0 (False) in this example (as it was the U2U relay UE that added the relay selection information associated with the relay chain to the DCR). In some examples, the relay selection information associated with the relay chain may be an ID of the U2N relay UE serving the relay chain and/or an ID of the other remote UE using the relay chain.

Following the addition of the relay selection information associated with the relay chain into the DCR, the U2U relay UE forwards the DCR of the remote UE towards the selected U2N relay UE utilizing the relay chain indicated in the relay selection information using SL unicast.

In some examples, when it is determined by the U2U relay UE that the U2U relay UE receiving the DCR (without relay selection information) from the remote UE is not serving any relay chains for other remote UEs, the U2U relay UE may forward the DCR of the remote UE using SL broadcast. The forwarding via broadcast may depend on other settings/information comprised in the DCR, such as for example, a maximum number of hops, timing information.

In some examples, when a DCR received at a U2U relay UE does not comprise relay selection information but the U2U relay UE is not able to accept the open DCR of the remote UE, the U2U relay UE may ignore the DCR of the remote UE.

In some examples, the U2U relay UE may be configured by the serving network and/or controlled by the remote UE to determine, upon receiving a response associated with the DCR of the remote UE from a U2N relay UE or a neighbouring U2U relay UE in the downlink direction (with SL-RSRP or RD-RSRP above a configured threshold), whether and how to further respond to the DCR of the remote UE.

In some examples, when the received response associated with the DCR for the remote UE is a DCA, then the U2U relay UE may send (or forward) the DCA towards the remote UE. The sending may either be: directly to the remote UE if the U2U relay UE receives the DCR from the remote UE, or via a selected neighbouring U2U relay UE from which the DCR of the remote UE was received. The selection of the selected neighbouring U2U relay UE prioritises the U2U relay UE that sent the DCR with relay selection information. This may apply using the same relay chain that is used for sending the DCR when the relay selection information is initiated by the remote UE (as indicated by the first indication).

In some examples, when the received response associated with the DCR for the remote UE is a DCRj and the DCRj is initiated by the U2N relay UE (based on the second indication and ID of the U2N relay UE), it may be determined by the receiving U2U relay UE whether it is serving another relay chain towards a different U2N relay

UE for another remote UE. In some examples, when the U2U relay UE is serving other relay chain(s) towards a different U2N relay UE(s) (compared to the relay chain associated with the received DCRj) that can be utilized for the remote UE (e.g. see the scenario of FIG. 5d), the U2U relay UE determines relay selection information associated with the other relay chain for the DCR of the remote UE for a reattempt. The U2U relay UE then includes the relay selection information associated with the other relay chain in the DCR of the remote UE. This may include replacing/overwriting the failed relay selection information. The U2U relay UE then forwards the DCR towards the (re) selected U2N relay UE utilizing the other relay chain indicated in the relay selection information using SL unicast.

The determination of the reattempt to establish a relay connection for the remote UE may occur if a timer or counter allows (associated with the DCR), meaning that the U2U relay UE may perform the reattempt only within the time limit set for the MH relay discovery and selection for the remote UE by the remote UE. This is referred to the timing information mentioned above. There may also be a maximum number of re-attempts configured for the DCR. For example, a maximum number of 2 re-attempts is allowed before the process is to end. In other examples, more or less than 2 re-attempts may be permitted/configured.

In some examples, a U2U relay UE sends/forwards a DCRj towards the remote UE, either directly to the remote UE if it received the DCR from the remote UE or via a selected neighbouring U2U relay UE from which the open DCR of the remote UE was received. The selection of the selected neighbouring U2U relay UE prioritizes a U2U relay UE that sent the DCR with relay selection information. In particular, there is a priority for using the same relay chain that is used for sending the DCR when the relay selection information is initiated by the remote UE (as indicated by the first indication).

In some examples, the DCRj may include a third indication (e.g. a 1-bit flag) to indicate at least one reattempt (or retry) with a relay (re) selection being performed. Thus, based on the third indication, a subsequent U2U relay UE or the remote UE may skip additional retry(s). Based on the DCRj, the subsequent U2U relay UE or the remote UE may know that the U2N relay UE that it selected (in the relay selection information) is not available regardless of outcome of the retry. The subsequent U2U relay UE or the remote UE, upon receiving the DCRj, may also initiate a retry (excluding the U2N relay UE that initiated the DCRj) while monitoring the outcome of the retry initiated by the U2U relay UE.

In some examples, the U2U relay UE forwards the DCRj towards the remote UE if the U2U relay UE does not find another relay chain for a retry or the retry also fails.

In some examples, when the DCRj has been initiated by another U2U relay UE (e.g. based on the second indication and ID of the source U2U relay UE of the DCRj), the U2U relay UE may determine whether to send the DCRj further towards the remote UE or not. Additionally or alternatively, the U2U relay UE may determine whether to perform a retry with relay (re) selection or not. This may be left up to the U2U relay UE's implementation.

In some examples, when the response to a DCR associated with a remote UE is a DR, the U2N relay UE may send the DR towards the remote UE. The DR may be sent directly to the remote UE if the U2U relay UE received the DCR from the remote UE, or via a maximum number of selected neighbouring U2U relay UE(s) from which the DCR of the remote UE was received. The maximum number of U2U relay UEs may be set/configured in the DCR by the remote UE or by the serving network.

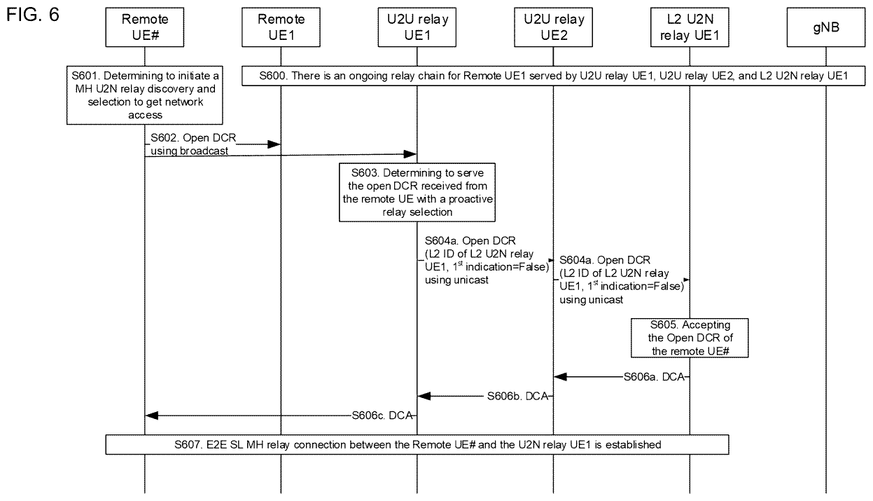

These examples and associated aspects will be described in more detail below, alongside FIGS. 6 to 8.

FIG. 6 shows an example signaling diagram for establishing a multi-hop relay connection. FIG. 6 is related to the example scenario provided in FIG. 5b.

At S600, there is an ongoing/established relay chain for a first remote UE (referred to as ‘remote UE1’) served by a first U2U relay UE (referred to as ‘U2U relay UE1’), a second U2U relay UE (referred to as ‘U2U relay UE2’), and a U2N relay UE (referred to as ‘L2 U2N relay UE1’). The L2 U2N relay UE1 is connected to a network, and has a serving gNB. The relay chain may also be referred to as an extended SL connection or MH SL between a remote UE and a U2N relay UE in an MH U2N relay connection for the remote UE, which is being served by one or more U2U relay UE(s).

At S601, there is provided a remote UE (referred to as ‘remote UE #’). The remote UE #is out-of-coverage of the network/gNB. The remote UE #initiates a MH U2N relay discovery and selection, in order to gain network access.

At S602, the remote UE #provides a request message associated with MH U2N relay connection establishment. In this manner, the request message may be associated with MH U2N relay discovery and selection. The request message may be a connection request, or a DCR. The connection request (or DCR) may be integrated with MH U2N relay discovery and selection, which may also referred to as the ‘open’ DCR.

The open DCR, as described above, enables (or otherwise facilitates) proactive MH U2N relay discovery and selection to be performed by either the remote UE or a U2U relay UE candidate that receives the open DCR of the remote UE by utilizing an established relay chain. The remote UE or the U2U relay UE candidate is aware of the established relay chain to due to, for example, that the remote UE or U2U relay UE candidate is serving the relay chain as a U2U relay UE, or an earlier discovery process, or the like. Based on performing the proactive MH U2N relay discovery and selection, the relay selection information comprising information associated with the established relay chain may be included in the open DCR by either the remote UE from the start (initiating the open DCR) or the U2U relay UE candidate that receives and forwards the open DCR of the remote UE for MH U2N relay connection establishment.

In some examples, the request message may comprise information associated with an established relay chain. For example, the information may comprise an identity (ID) of a U2N relay UE and/or an ID of a remote UE associated with the relay chain. The information may further comprise ID(s) of U2U relay UE(s) associated with the relay chain.

In the example of FIG. 6 (related to the example scenario in FIG. 5b), the remote UE #has no SL connection established with any U2U relay UE or U2N relay UE beforehand. Thus, the request message does not comprise information associated with an established relay chain, also referred to as the relay selection information. Stated differently, the remote UE #refrains from including information associated with an established relay chain. This may be because the remote UE #is not aware of any established relay chains that may be utilized by the remote UE #for its MH U2N relay connection establishment. It is noted that the remote UE #may be acting as a U2U relay UE in (a separate) established relay chain(s) for other remote UE(s), as in examples of FIGS. 5c and 5d. The request message may be broadcast by the remote UE #. The request message is assumed to reach the remote UE1 and the U2U relay UE1 which are in proximity of the remote UE #as illustrated in FIG. 5b.

In some examples, the request message may comprise information indicative of that the request message is the ‘open’ DCR with integrated MH U2N relay discovery and selection. The information that is indicative may be referred to as the MH U2N relay enabled indication. The information that is indicative may comprise at least one of the following: a relevant UE ID(s) of the remote UE (the remote UE may also act as U2U relay UE for other remote UE), an authorized PLMN ID(s) of the remote UE, a maximum allowed number of hops for the requested MH U2N relay of the remote UE, timing information such as a terminating time of the DCR, or a maximum allowed number of reattempt for proactive relay (re) selection by a U2U relay UE candidate for the remote UE.

At S603, the U2U relay UE1 receives the request message from the remote UE #. The U2U relay UE1 may determine to serve the request. Based on the request message, the U2U relay UE1 determines whether to perform a relay selection.

The U2U relay UE1 determines whether the request message comprises information associated with an established relay chain. In this manner, the U2U determines whether to perform a relay selection for the request message (e.g. the open DCR) of the remote UE #.

When the request message comprises the information associated with an established relay chain, the U2U relay UE1 uses the information to forward the request message using the established relay chain. For example, the request message comprises an ID of U2N relay UE1.

When the request message does not comprise information associated with an established relay chain, the U2U relay UE1 determines/discovers one or more established relay chains that may be utilized for the request of the remote UE.

In this example of FIG. 6, the U2U relay UE1 has an established relay chain with the U2N relay UE1, as for serving the remote UE1. The U2U relay UE1 retrieves (or determines) information with the established relay chain, where the information comprises the ID of the U2N relay UE1 and/or the ID of the remote UE1. The information about the established relay chain is available to the U2U relay UE1. In this manner, the information is associated with relay selection information. The U2U relay UE1 inserts the information into the request message. In this manner, the U2U relay UE1 may be inserting the information into the open DCR. Stated differently, the U2U relay UE1 updates the request message to include the information. Following the insertion, the request comprises the information associated with relay selection indicating the established relay chain including at least an identity of the U2N relay UE.

At S604a, the U2U relay UE1 provides the request message to the U2N relay UE1, via U2U relay UE2. The request message is provided using the established relay chain, via unicast.

In order to differentiate a relay selection initiated by a remote UE from a relay selection initiated by a U2U relay UE, a first indication may be provided in the request message along with the information. The indication may be included by the U2U relay UE1. The indication may be, for example, a flag. For example, the first indication is set to 1 (e.g. true) when the relay selection information was provided by the remote UE # (e.g. the relay selection was initiated by the remote UE #), or the first indication is set to 0 (e.g. false) when the relay selection information was provided by the U2U relay UE1 (e.g. the relay selection was initiated by the U2U relay UE1). In other examples, the two options for the first indication are switched.

In this example, the request message comprises a first indication set to ‘false’. This indicates that the relay selection information was provided by the U2U relay UE1.

At S605, the U2N relay UE1 receives the request message. The U2N relay UE1 determines whether to accept the request message. The U2N relay UE1 may determine whether to respond with a direct communication accept (DCA), direct communication reject (DCRj) or discovery response (DR). This may be determined based on an implementation of the U2N relay UE1.

In this example, the U2N relay UE1 determines to accept the request from the remote UE #.

At S606a to S606c, a message accepting the request (e.g. a DCA) is provided to the remote UE #, via the U2U relay UE2 and the U2U relay UE1.

At S607, an E2E SL MH relay connection is established for the remote UE # and U2N relay UE1.

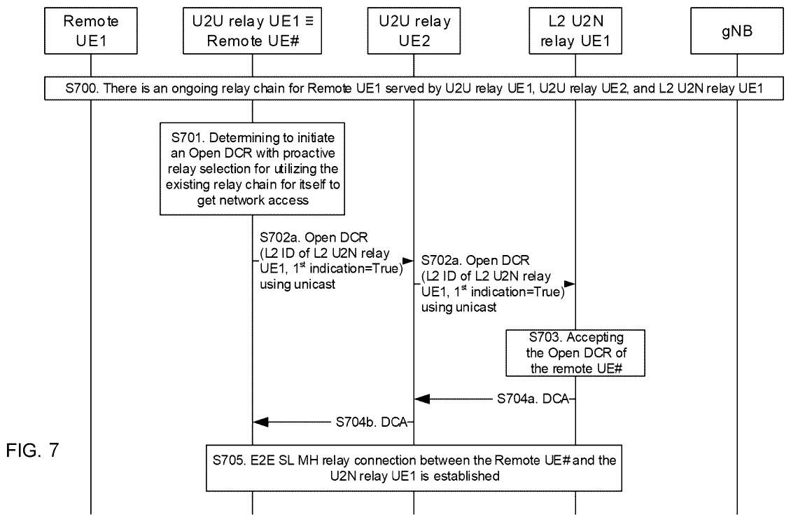

FIG. 7 shows an example signaling diagram for establishing a multi-hop relay connection. FIG. 7 is related to the example scenario provided in FIG. 5c.

FIG. 7 shows a similar example to that of FIG. 6, with the difference that the remote UE # (that is requesting a relay connection) is the same as a U2U relay UE (that is serving an established relay chain for another remote UE). Stated differently, the remote UE #is already configured as part of a relay chain for another remote UE (e.g. remote UE1). The remote UE #is acting as the U2U relay UE1 for the relay chain between the remote UE1 and the U2N relay UE1.

At S700, there is an ongoing/established relay chain for a first remote UE (referred to as ‘remote UE1’) served by a first U2U relay UE (referred to as ‘U2U relay UE1’), a second U2U relay UE (referred to as ‘U2U relay UE2’), and a U2N relay UE (referred to as ‘L2 U2N relay UE1’). The L2 U2N relay UE1′ is connected to a network, and has a serving gNB. The relay chain may be referred to as an extended SL connection. The relay chain may be referred to as an MH SL between a remote UE and a U2N relay UE in a MH U2N relay connection.

At S701, the remote UE #initiates a MH U2N relay discovery and selection, in order to gain network access. The remote UE #initiates a request message associated with MH U2N relay connection establishment. In this manner, the request message may be associated with MH U2N relay discovery and selection. The request message may be a connection request. The request message may be a DCR that is integrated with MH U2N relay discovery and selection (also referred to as an open DCR).

In some examples, the request message comprises information associated with an established relay chain. For example, the information may comprise an identity (ID) of a U2N relay UE and/or ID of a remote UE associated with the relay chain. As the remote UE #is already acting as a U2U relay UE for the remote UE1, the remote UE # is aware of the established relay chain.

The remote UE #inserts the information associated with the relay chain into the request message. Following the insertion, the request comprises information associated with relay selection indicating the established relay chain including at least an identity of the U2N relay UE.

At S702a, the remote UE #/U2U relay UE1 provides the request message towards the U2N relay UE1, via the U2U relay UE2, using the established relay chain. The request message is provided using unicast. The U2N relay UE1 is identified based on the information.

In order to differentiate a relay selection initiated by a remote UE from a relay selection initiated by a U2U relay UE, a first indication may be provided in the request message along with the information. The indication may be, for example, a flag. For example, the first indication is set to 1 (e.g. true) when the relay selection information was provided by the remote UE # (e.g. the relay selection was initiated by the remote UE #), or the first indication is set to 0 (e.g. false) when the relay selection information was provided by the U2U relay UE1 (e.g. the relay selection was initiated by the U2U relay UE1). In other examples, the two options for the first indication are switched.

In this example, the request message comprises a first indication set to ‘true’. This indicates that the relay selection information was provided by the remote UE # (which is the same as U2U relay UE1).

At S703, the U2N relay UE1 receives the request message. The U2N relay UE1 determines whether to accept the request message. The U2N relay UE1 may determine whether to respond with a direct communication accept (DCA), direct communication reject (DCRj) or discovery response (DR). This may be determined based on an implementation of the U2N relay UE1.

In this example, the U2N relay UE1 determines to accept the request from the remote UE #.

At S704a to S704b, a message accepting the request (e.g. a DCA) is provided to the remote UE #, via the U2U relay UE2.

At S705, an E2E SL MH relay connection is established between the remote UE #and U2N relay UE1.

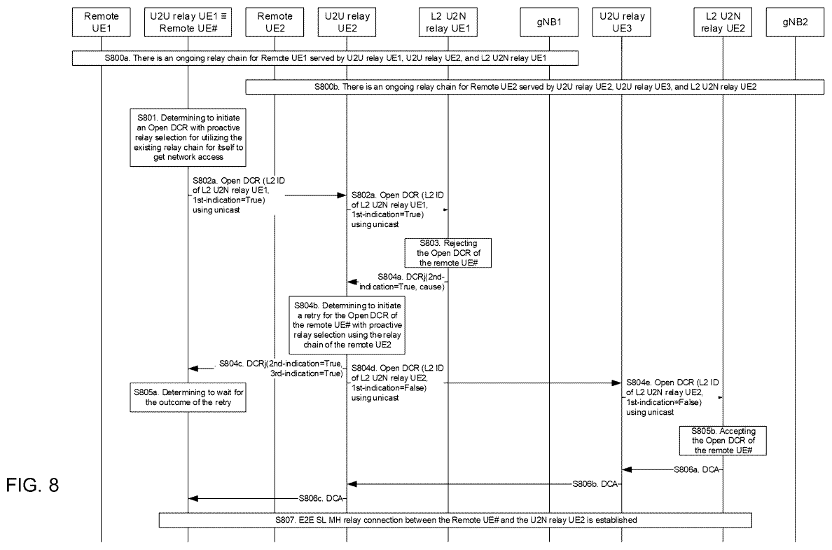

FIG. 8 shows another example signaling diagram for establishing a multi-hop relay connection. FIG. 8 is related to the example scenario provided in FIG. 5d.

FIG. 8 is similar to FIG. 7 in that a remote UE # (that is requesting a relay connection) is the same as a U2U relay UE (that is serving an established relay chain for another remote UE). Stated differently, the remote UE #is already configured as part of a relay chain for another remote UE (e.g. remote UE1). The remote UE #is acting as the U2U relay UE1 for the relay chain between the remote UE1 and the U2N relay UE1.

At S800a, there is an ongoing/established relay chain for a first remote UE (referred to as ‘remote UE1’) served by a first U2U relay UE (referred to as ‘U2U relay UE1’), a second U2U relay UE (referred to as ‘U2U relay UE2’), and a U2N relay UE (referred to as ‘L2 U2N relay UE1’). The L2 U2N relay UE1′ is connected to a network, and has a serving gNB. The relay chain may be referred to as an extended SL connection. The relay chain may also be referred to as an MH SL between a remote UE and a U2N relay UE in a MH U2N relay connection.

At S800b, there is a further established relay chain for a remote UE2, served by U2U relay UE2, U2U relay UE3, and L2 U2N relay UE2.

In this manner, in the example of FIG. 8, there is an established relay chain for the remote UE1, and a further established relay chain for the remote UE2.

At S801, the remote UE #initiates a MH U2N relay discovery and selection, in order to gain network access. The remote UE #initiates a request message associated with MH U2N relay connection establishment. In this manner, the request message may be associated with MH U2N relay discovery and selection. The request message may be a connection request. The request message may be a DCR that is integrated with MH U2N relay discovery and selection (also referred to as an open DCR).

In some examples, the request message comprises information associated with an established relay chain. For example, the information may comprise an identity (ID) of a U2N relay UE and/or an ID of a remote UE associated with the relay chain. As the remote UE #is already acting as a U2U relay UE for the remote UE1, the remote UE # is aware of the established relay chain.

The remote UE #inserts the information associated with the relay chain into the request message. In this example, the ID of U2N relay UE1 is included. Following the insertion, the request comprises information associated with relay selection indicating the established relay chain including at least an identity of the U2N relay UE.

At S802a, the remote UE #/U2U relay UE1 provides the request message towards the U2N relay UE1, via the U2U relay UE2, using the established relay chain. The request message is provided using unicast. The U2N relay UE1 is identified based on the information.

In order to differentiate a relay selection initiated by a remote UE from a relay selection initiated by a U2U relay UE, a first indication may be provided in the request message along with the information. The indication may be, for example, a flag. For example, the first indication is set to 1 (e.g. true) when the relay selection information was provided by the remote UE # (e.g. the relay selection was initiated by the remote UE #), or the first indication is set to 0 (e.g. false) when the relay selection information was provided by the U2U relay UE1 (e.g. the relay selection was initiated by the U2U relay UE1). In other examples, the two options for the first indication are switched.

In this example, the request message comprises a first indication set to ‘true’. This indicates that the relay selection information was provided by the remote UE # (which is the same as U2U relay UE1).

At S803, the U2N relay UE1 receives the request message. The U2N relay UE1 determines whether to accept the request message. The U2N relay UE1 may determine whether to respond with a direct communication accept (DCA), direct communication reject (DCRj) or discovery response (DR). This may be determined based on an implementation of the U2N relay UE1.

In this example, the U2N relay UE1 determines to reject the request from the remote UE #. The reject message may be a DCRj.

When the request is to be rejected, the rejection (e.g. DCRj) may include a second indication to indicate whether the DCRj is initiated from a U2N relay UE or a U2U relay UE. The second indication may be, for example, a 1-bit flag. For example, when the DCRj is initiated by the U2N relay UE, then the second indication is set to 1 (true). When the DCRj is initiated by the U2U relay UE, then the second indication is set to 0 (false). In other examples, these two options are switched.

At S804a, the U2N relay UE1 provides the reject message to U2U relay UE2, where the second indication is set to 1 (true).

At S804b, the U2U relay UE2 receives the reject message, and determines to resend the request for MH U2N relay establishment for the remote UE #. In other examples, the U2U relay UE2 receives the reject message, and determines to resend the open DCR with a relay reselection for MH U2N relay establishment for the remote UE #. Stated differently, the U2U relay UE2 determines to retry the establishment for a MH U2N relay connection for the remote UE #.

The U2U relay UE2 is part of the further established relay chain for the remote UE2.

At S804c, the U2U relay UE2 provides the reject message to the remote UE #/U2U relay UE1. The reject message comprises the second indication.

The reject message (e.g. DCRj) may also include a third indication to indicate at least one retry with proactive relay (re) selection is performed for the open DCR of the remote UE. The third indication may be, for example, a 1-bit flag. The third indication being set to 1 (true) when a retry has been attempted. Based on the third indication, subsequent retries by the U2U relay UE or the remote UE may be skipped. Based on the reject message, the receiving U2U relay UEs or the remote UE #may know that the U2N relay UE1 it selected is not available (regardless of outcome of the retry).

At S804d, the U2U relay UE2 provides the request message to U2N relay UE2, via U2U relay UE3 (S804e), using the further established relay chain. The request message is transmitted via unicast. The request message comprises information associated with the further established relay chain. For example, an ID of U2N relay UE2 and/or an ID of remote UE2. In the request message, the first indication is set to 0 (false).

At S805a, the remote UE #receives the reject message and determines to wait for the outcome of the retry. The remote UE #is aware of the retry based on the third indication being set to true. In some examples, the subsequent U2U relay UE or the remote UE, upon receiving the DCRj, may also initiate a retry excluding the U2N relay UE that initiated the DCRj while monitoring the outcome of the retry initiated by the U2U relay UE. In another example, the U2U relay UE2 only forwards the DCRj towards the remote UE #if it does not find another relay chain for a retry or the retry also fails.

At S805b, the U2N relay UE2 receives the request message. The U2N relay UE2 determines whether to accept the request message. The U2N relay UE2 may determine whether to respond with a direct communication accept (DCA), direct communication reject (DCRj) or discovery response (DR). This may be determined based on an implementation of the U2N relay UE2.

In this example, the U2N relay UE2 determines to accept the request from the remote UE #.

At S806a to S806c, a message accepting the request (e.g. a DCA) is provided to the remote UE #, via U2U relay UE3 and U2U relay UE2.

At S807, an E2E SL MH relay connection is established between the remote UE #and U2N relay UE2.

It should be understood that one or more of the signaling steps in any of FIGS. 6 to 8 may not be performed in some examples, or may be performed in a different order. In some examples, one or more of the signaling steps in any of FIGS. 6 to 8 may be combined. In some examples, one or more intermediate signaling steps may be performed between the signaling shown in any of FIGS. 6 to 8.

In some examples, a remote UE may control the relay selection by U2U relay UEs for subsequent retries for a DCR of the remote UE via respective control information elements included in the DCR. The control information elements may indicate whether the relay selection by U2U relay UE is enabled or disabled. The control information elements may indicate whether a reattempt or retry with a relay (re) selection by a U2U relay UE for the open DCR of the remote UE is enabled or disabled. The control information elements may further indicate whether parallel reattempts or retries with relay (re) selections by U2U relay UEs for the open DCR of the remote UE is enabled or disabled. The control information elements may set the maximum number of hops for MH U2N relay connection for the remote UE that may be used for relay selection by U2U relay UE. The control information elements may set a counter limit for the number of retries with relay (re) selections by the same U2U relay UE.

In some examples, at least some of the control information elements may be configured by a serving network that is common to all relevant UEs using system information blocks (SIBs), dedicated signaling or pre-configuration for supporting both IC and OoC operations.

In some examples, a remote UE may indicate an ending timer of the DCR procedure within the DCR message. The ‘ending timer’ may be timer, counter, or the like. Based on the ending timer, U2U relay UE or U2N relay UE may determine whether to be involved in the request or release its involvement in serving the DCR of the remote UE. The ending timer may be considered as part of the timing information included in the request message or, that is, the open DCR.

In some examples, a DCA that is initiated from a U2N relay UE in response to the DCR of the remote UE may indicate a number of instances of the DCR the U2N relay UE has received. The number of instances represents alternative connections to reach the U2N relay UE and therefore may be used by the remote UE to select a U2N relay UE and associated relay chain if more than one relay chains via different U2N relay UEs are established.

In some examples, different DCR messages issued by different remote UEs may be combined into a single DCR by a U2U relay UE to forward to next U2U relay UE(s) or U2N relay UE(s). The combination may occur when the U2U relay UE receives different DCR messages for different remote UEs and determines to be involved for more than one DCR among the received DCRs. The same may be applied for different DCA messages or different DCRj messages.

In some examples, at least U2U relay UE member(s) of an existing/established MH U2N relay connection or relay chain may advertise or announce, in a discovery announcement message for example, the existence of the relay chain and optionally include information about the relay chain. The information about the relay chain may comprise at least one of the following: ID of the U2N relay UE, ID of the remote UE, ID(s) of the U2U relay UE(s), ID of serving PLMD, ID of serving Cell, number of hops, etc., in the discovery announcement message. The U2U relay UE member(s) may transmit this announcement message via broadcast. Thus, another remote UE that receives such announcement(s) from one or more U2U relay UE(s) may use the received announcement(s) to discover established relay chains that may be utilized for fast and efficient MH U2N relay connection establishment.

In some examples, a system information block (SIB), such as SIB1 of the serving cell of the U2N relay UE may be provided along with a response message from the U2N relay UE to the remote UE (in response to the DCR from the remote UE). The response may be DCA, DCRj, or DR.

In some examples, a reason (or cause) for rejection of the open DCR from a remote UE is included in a DCRj from a U2N relay UE. The reason/cause may be selected from a preconfigured list of pre-defined causes associated with corresponding cause values. Examples of cause values may be: U2N or U2U relay UE's bandwidth, and Uu or SL congestion. This will help the closest U2U relay UE who receives this DCRj to take a decision on “mitigation”. For example, a load problem at the U2N relay may trigger finding an alternative U2N relay served by the same gNB. In another example, Uu congestion (e.g. core network congestion) may trigger finding an alternative U2N relay served by another gNB.

One or more of the examples discussed above provide a mechanism whereby established or existing relay chains for MH U2N relay may be used by a remote UE to find or establish a MH U2N relay connection. This has the advantage that a MH U2N relay connection is established more quickly for the remote UE and the problem of message flooding in MH U2N relay discovery and selection is reduced.

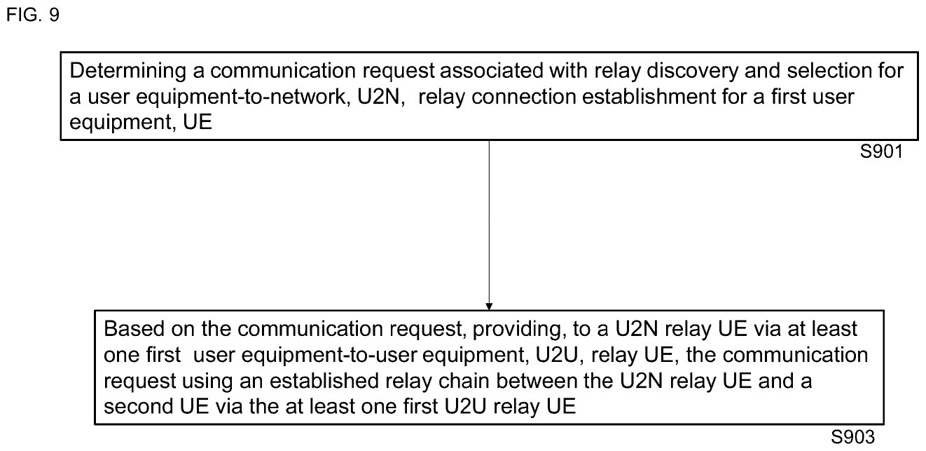

FIG. 9 shows an example method flow performed by an apparatus. In some examples, the apparatus is for a first UE. In some examples, the apparatus is comprised in a first UE. In examples, the apparatus is a first UE. In some examples, the apparatus is for a U2U relay UE. In some examples, the apparatus is comprised in a U2U relay UE. In some examples, the apparatus is a U2U relay UE. In some examples, the apparatus is for a U2U relay UE of an established relay chain. In some examples, the apparatus is for a first UE and also for a U2U relay UE of an established relay chain.

In S901, the method comprises determining a communication request associated with relay discovery and selection for a user equipment-to-network, U2N, relay connection establishment for a first user equipment, UE.

In S903, the method comprises based on the communication request, providing, to a U2N relay UE via at least one first user equipment-to-user equipment, U2U, relay UE, the communication request using an established relay chain between the U2N relay UE and a second UE via the at least one first U2U relay UE.

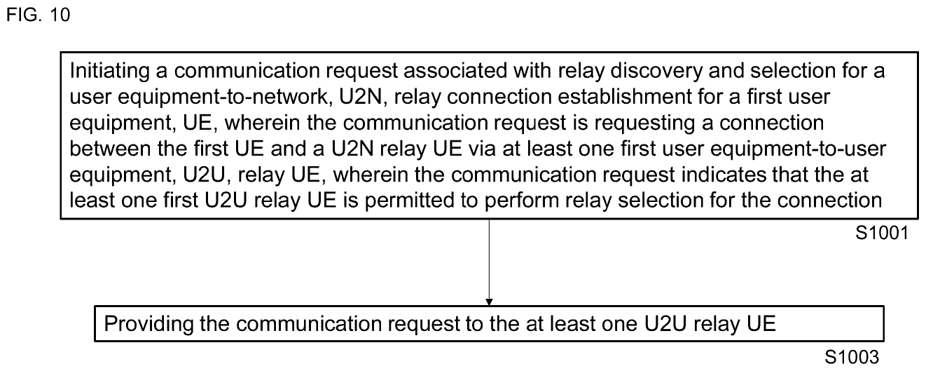

FIG. 10 shows an example method flow performed by an apparatus. In some examples, the apparatus is for a first UE. In some examples, the apparatus is comprised in a first UE. In some examples, the apparatus is a first UE.

In S1001, the method comprises initiating a communication request associated with relay discovery and selection for a user equipment-to-network, U2N, relay connection establishment for a first user equipment, UE, where the communication request is requesting a connection between the first UE and a U2N relay UE via at least one first user equipment-to-user equipment, U2U, relay UE, where the communication request indicates that the at least one first U2U relay UE is permitted to perform relay selection for the connection.

In S1003, the method comprises providing the communication request to the at least one U2U relay UE.

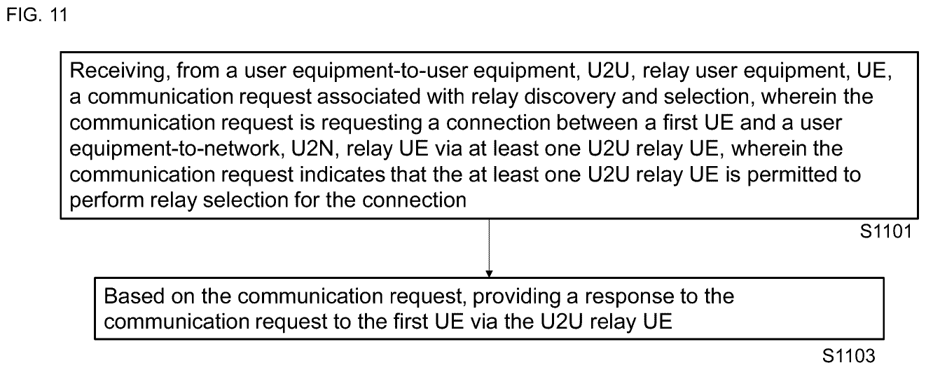

FIG. 11 shows an example method flow performed by an apparatus. In some examples, the apparatus is for a U2N relay UE. In some examples, the apparatus is comprised in a U2N relay UE. In some examples, the apparatus is a U2N relay UE.

In S1101, the method comprises receiving, from a user equipment-to-user equipment, U2U, relay user equipment, UE, a communication request associated with relay discovery and selection, where the communication request is requesting a connection between a first UE and a user equipment-to-network, U2N, relay UE via at least one U2U relay UE, where the communication request indicates that the at least one U2U relay UE is permitted to perform relay selection for the connection.

In S1103, the method comprises based on the communication request, providing a response to the communication request to the first UE via the U2U relay UE.

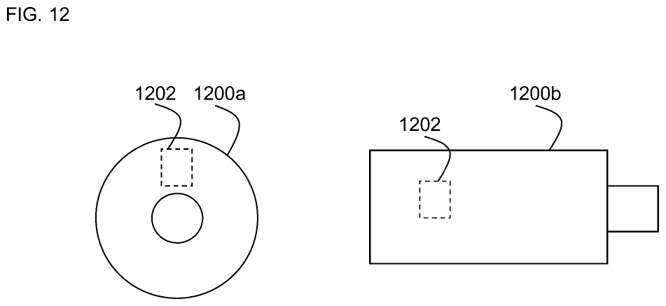

FIG. 12 shows a schematic representation of non-volatile memory media 1200a (e.g. blu-ray disc (BD), computer disc (CD) or digital versatile disc (DVD)) and 1200b (e.g. flash memory, solid state memory, universal serial bus (USB) memory stick) storing instructions and/or parameters 1202 which when executed by at least one processor allow the at least one processor to perform one or more of the steps of the methods of FIG. 9, FIG. 10 or FIG. 11.

It is noted that while the above describes various examples, there are several variations and modifications which may be made to the various examples without departing from the scope of the disclosure.

The examples may thus vary within the scope of the disclosure. In general, some examples may be implemented in hardware or special purpose circuits, software, logic or any combination thereof. For instance, some examples may be implemented in hardware, while other examples may be implemented in firmware or software which may be executed by a controller, microprocessor or other computing device, although such examples are not limited thereto. While various examples may be illustrated and described as block diagrams, flow charts, or using some other pictorial representation, it is well understood that these blocks, apparatus, systems, techniques or methods described herein may be implemented in hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard, it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The term “non-transitory”, as used herein, is a limitation of the medium itself (e.g., tangible, not a signal) as opposed to a limitation on data storage persistency (e.g. RAM vs ROM).

As used herein, “at least one of the following: <a list of two or more elements>” and “at least one of: <a list of two or more elements>” and similar wording, where the list of two or more elements are joined by “and”, or “or”, mean at least any one of the elements, or at least any two or more of the elements, or at least all of the elements. As used herein, the expression “and/or” includes any and all combinations of one or more of the listed terms.

As used herein, unless stated explicitly, performing a step “in response to A” does not necessarily indicate that the step is performed immediately after “A” occurs as one or more intervening steps may be included.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

As used herein, the term “means for”, or “means configured to perform” (or similar) may be any means that are suitable for performing the feature. The “means” may be configured to perform one or more of the functions and/or method steps previously described. For example, the “means” may include one or more of: at least one processor, at least one memory, transceiver circuitry, antenna circuitry, etc. It should be understood that these are provided as examples herein.

Additionally or alternatively, some examples may be implemented using circuitry. The circuitry may be configured to perform one or more of the functions and/or method steps previously described. That circuitry may be provided in the base station and/or in the communications device.

As used herein, the term “circuitry” may refer to one or more or all of the following examples:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to uses of the term “means” herein, including in any claims. As a further example, as used herein, the term circuitry also covers an implementation of merely a hardware circuit or processor (or multiple processors) or portion of a hardware circuit or processor and its (or their) accompanying software and/or firmware. The term circuitry also covers, for example integrated device. The term circuitry also covers, for example and if applicable to the particular claim element, a baseband integrated circuit or processor integrated circuit for a mobile device or a similar integrated circuit in a server, a cellular network device, or other computing or network device.

The foregoing description has provided, by way of exemplary and non-limiting and illustrative examples, a full and informative description of some examples of the disclosure. However, various modifications and adaptations may become apparent to those skilled in the relevant arts in view of the foregoing description, when read in conjunction with the accompanying drawings and the claims. However, all such and similar modifications of the teachings will still fall within the scope of the disclosure.

1. An apparatus comprising at least one processor, and at least one memory storing instructions that, when executed by the at least one processor, cause the apparatus to perform:
determining a communication request associated with relay discovery and selection for a user equipment-to-network, U2N, relay connection establishment for a first user equipment, UE; and
based on the communication request, providing, to a U2N relay UE via at least one first user equipment-to-user equipment, U2U, relay UE, the communication request using an established relay chain between the U2N relay UE and a second UE via the at least one first U2U relay UE.

2. The apparatus according to claim 1, wherein the apparatus being caused to determine the communication request comprises the apparatus being caused to perform one of:
receiving the communication request from at least one of: the first user equipment or at least one second U2U relay UE, or
initiating the communication request.

3. The apparatus according to claim 1, wherein the communication request comprises information associated with relay selection indicating the established relay chain including at least an identity of the U2N relay UE.

4. The apparatus according to claim 1, wherein the instructions, when executed by the at least one processor, further cause the apparatus to perform:
determining whether the communication request comprises information associated with relay selection;
when it is determined that the communication request comprises information associated with relay selection, selecting the U2N relay UE using the established relay chain based on the information associated with relay selection;
when it is determined that the communication request does not comprise information associated with relay selection:
retrieving first information associated with relay selection from the established relay chain, wherein the first information comprises information indicating the established relay chain including at least the identity of the U2N relay UE, and
inserting the first information into the communication request.

5. The apparatus according to claim 1, wherein the instructions, when executed by the at least one processor, further cause the apparatus to perform:
receiving, from the U2N relay UE directly or via at least one U2U relay UE, an accept message associated with the communication request, wherein the accept message indicates an acceptance of the communication request; and
providing, to the first user equipment, the accept message.

6. The apparatus according to claim 1, wherein the instructions, when executed by the at least one processor, further cause the apparatus to perform:
receiving a reject message associated with the communication request, wherein the reject message indicates a rejection of the communication request;
based on receiving the reject message:
retrieving second information associated with relay selection from a further established relay chain, wherein the second information comprises an identity of a further U2N relay UE,
replacing the first information with the second information in the communication request, and
providing, to the further U2N relay UE, the communication request using the further established relay chain.

7. The apparatus according to claim 6, wherein the reject message is received from one of: the U2N relay UE directly, the U2N relay UE via at least one U2U relay UE, the U2U relay in the established relay chain directly, or the U2U relay UE in the established relay chain via at least one other U2U relay UE in the established relay chain.

8. The apparatus according to claim 1, wherein the communication request comprises a flag, wherein the flag indicates whether the information associated with relay selection in the communication request was initiated by: the first UE, or a U2U relay UE.

9. The apparatus according to claim 1, wherein one of: the apparatus is for the first UE, the apparatus is comprised in the first UE, the apparatus is the first UE, the apparatus is for a U2U relay user equipment, the apparatus is comprised in a U2U relay user equipment, the apparatus is a U2U relay user equipment.

10. The apparatus according to claim 1, wherein one of: the apparatus is for a U2U relay UE of the established relay chain, or the apparatus is for the first UE and also for a U2U relay UE of the established relay chain.

11. An apparatus comprising at least one processor, and at least one memory storing instructions that, when executed by the at least one processor, cause the apparatus to perform:
initiating a communication request associated with relay discovery and selection for a user equipment-to-network, U2N, relay connection establishment for a first user equipment, UE, wherein the communication request is requesting a connection between the first UE and a U2N relay UE via at least one first user equipment-to-user equipment, U2U, relay UE, wherein the communication request indicates that the at least one first U2U relay UE is permitted to perform relay selection for the connection; and
providing the communication request to the at least one U2U relay UE.

12. The apparatus according to claim 11, wherein the communication request comprises information associated with relay selection indicating an established relay chain between a U2N relay UE and a second UE via the at least one U2U relay UE including at least an identity of the U2N relay UE, to be used for the connection.

13. The apparatus according to claim 11, wherein the instructions, when executed by the at least one processor, further cause the apparatus to perform:
communicating with a network using the connection that is established between the first UE and the U2N relay via the at least one first U2U relay UE.

14. The apparatus according to claim 11, wherein one of: the apparatus is for the first UE, the apparatus is comprised in the first UE, or the apparatus is the first UE.

15. An apparatus comprising at least one processor, and at least one memory storing instructions that, when executed by the at least one processor, cause the apparatus to perform:
receiving, from a user equipment-to-user equipment, U2U, relay user equipment, UE, a communication request associated with relay discovery and selection, wherein the communication request is requesting a connection between a first UE and a user equipment-to-network, U2N, relay UE via at least one U2U relay UE, wherein the communication request indicates that the at least one U2U relay UE is permitted to perform relay selection for the connection; and
based on the communication request, providing a response to the communication request to the first UE via the U2U relay UE.

16. The apparatus according to claim 15, wherein the apparatus being caused, based on the communication request, to provide a response to the communication request to the first UE via the U2U relay UE comprises the apparatus being caused to perform:
based on the communication request, determining whether to respond with one of: an accept message associated with the communication request, a reject message associated with the communication request, or a relay discovery message associated with the communication request; and
based on the determination, providing the response to the first UE via the U2U relay UE.

17. The apparatus according to claim 16, wherein, when it is determined to provide a reject message associated with the communication request, the instructions, when executed by the at least one processor, further cause the apparatus to perform:
including a reject flag with the reject message associated with the communication request in the response, wherein the reject flag indicates that the reject message was initiated by the U2N relay UE.

18. The apparatus according to claim 16, wherein when it is determined to respond with the relay discovery message associated with the communication request, the instructions, when executed by the at least one processor, further cause the apparatus to perform: selecting one or more U2U relay UEs from the at least one U2U relay UE; and sending the response to the selected one or more U2U relay UEs individually.

19. The apparatus according to claim 15, wherein one of: the apparatus is for the U2N relay UE, the apparatus is comprised in the U2N relay UE, or the apparatus is the U2N relay UE.
